(19) United States
(12) Patent Application Publication
(10) Pub. No.: US 2003/0112369 A1
(43) Pub. Date: Jun. 19, 2003

(54) Apparatus and method for deinterlace of video signal

(76) Inventors: Dae-Woon Yoo, Seoul (KR); Du-Sik Yang, Seoul (KR)

Correspondence Address: JACOBSON HOLMAN PLLC, 400 SEVENTH STREET N.W., SUITE 600, WASHINGTON, DC, 20004, US

(21) Appl. No.: 10/315,999

(22) Filed: Dec. 11, 2002

(30) Foreign Application Priority Data
Dec. 14, 2001 (KR) 2001-79277

(51) Int. Cl. H04N 7/01

(52) U.S. Cl. 348/448; 348/452

(57) ABSTRACT

There is provided a method for deinterlacing image signals, which is capable of improving a definition of boundary portions when converting an interlaced scanning image into a progressive scanning image, and recovering a fast-motion image or a film image to be close to an original image. The method of the present invention includes the steps of: finding boundary portions between image data of line of a predetermined current field and image data of a previous line, and obtaining to-be-interpolated data within field according to the boundary portions; extracting a motion value using the image data of the current field and two-field delayed image data; extracting a film image based on the extracted motion value; comparing the extracted motion value with a one-field delayed motion value and detecting a fast motion image; and generating image data by interpolating lines of the obtained to-be-interpolated data and the previous field data according to the motion value, the detected fast motion image and the detected film image.

### BACKGROUND OF THE INVENTION

1. Field of the Invention

The present invention relates to a method for deinterlacing video signals, and more particularly, to apparatus and method for deinterlacing video signals, in which picture quality of boundary portions can be improved by solving a step phenomenon occurring in the boundary portions when converting an interlaced scanning image consisting of field into a progressive scanning image consisting of the same number of frames. In addition, a horizontal moire remaining image can be prevented using the small number of field memory devices with respect to partial images having fast motion, and the interlaced scanning image can be converted into the progressive scanning image while maintaining a picture quality of original image with respect to film mode images.

2. Description of the Related Art

Generally, display of interlaced scanning images is implemented by alternating odd fields corresponding to an odd line group of screen and even fields corresponding to an even line group thereof with a predetermined time difference.

Systems using the interlaced scanning method include a typical analog television, a video camera, a VCR, etc. The system's signal processing, such as a transmission, a storage, a display and the like, is performed in the interlaced scanning method. In digital televisions of ATSC standard, 1920×1080i and 720×840i formats are based on the interlaced scanning. Systems using the progressive scanning method are focused on personal computers (PCs) and the display of most PCs is achieved using the progressive scanning method. In digital televisions, 1280×720p and 720×480p formats are based on the progressive scanning method. The reason that the image processing is classified into two methods (i.e., the interlaced scanning method and the progressive scanning method) is because contents of to-be-displayed images are different from each other. In other words, if the same frequency bandwidth is given, the interlaced scanning method is advantageous to display moving pictures since it can provide excellent picture quality. Meanwhile, the progressive scanning method is advantageous to display PC images having a large number of lines, dots and still pictures.

However, in case the moving pictures and the PC images are simultaneously displayed on one device, the progressive scanning method is generally used. That reason is because degradation of picture quality is conspicuous if the still pictures consisting of dots and lines are displayed based on the interlaced scanning method. In addition, the scanning method is different according to the display devices. The display device employing CRT that is widely used in televisions must perform high-voltage deflection. Therefore, in order to slightly vary high-voltage current, the interlaced scanning method having a small horizontal frequency is advantageous. Meanwhile, flat-panel display devices using PDP, LCD and DLP do not perform the high-voltage deflection. Therefore, the flat-panel display devices use the progressive scanning method more than the interlaced scanning method that has several disadvantages such as line flicker, large area flicker, detection of long scanning line, etc.

In a digital era, most images are processed in a digital mode. The digitally processed images may be stored in HDD of PC or displayed on the PC's screen. On the contrary, there are many users who want to display PC images on television screens. In a digital television era, with an advance of large screen/high definition, the focus is gradually changed from the CRT-based display devices to the flat-panel display devices that are light and provide the large screen.

For these reasons, there is required a deinterlace process of converting moving pictures of the interlaced scanning into those of the progressive scanning. As methods for implementing the deinterlace with simple hardware, there are a line repetition method, an intra-field interpolation method and an inter-field interpolation method.

The line repetition method generates the to-be-interpolated line by simply repeating the above line disposed within the same field. Although the line repetition method can be implemented with simplest hardware, there is a disadvantage that the picture quality is degraded since the boundary of an inclined line after the interpolation is seen in a stepped shape.

The intra-field interpolation method obtains a to-be-interpolated pixel value through an arithmetical calculation such as addition and division using upper and lower pixels disposed at the same field as the to-be-interpolated pixel. The intra-field interpolation method can reduce the step phenomenon compared with the line repetition method. However, since the intra-field interpolation method makes frames using information of one field with respect to the still pictures, there is a disadvantage that vertical resolution is degraded to an extent of half the resolution.

The inter-field interpolation method is implemented by taking and inserting the line disposed at the same position of just previous field into the to-be-interpolated line of current field. The inter-field interpolation method can obtain excellent vertical resolution with respect to the still pictures. However, since that is similar to the overlap of two pictures whose timing is somewhat different from each other, the inter-field interpolation method has a disadvantage that the flicker may occur in pictures having entirely the motion and the horizontal moire remaining images may occur toward a moving direction of the objects in pictures having the locally moving objects.

It is desirable that the above-described hardware should be not used since the conversion of the interlaced scanning image into the progressive scanning image result in the degradation of the picture quality. Although hardware is complicated, one method for solving the problems is to detect the motion states of pixels disposed adjacent to the to-be-interpolated pixel and select one of the intra-field interpolation method and the inter-field interpolation method according to the detected motion value. In this case, the inter-field interpolation method is performed with respect to the still pictures so as to maintain the vertical resolution, and the intra-field interpolation method is performed with respect to the objects having the motion so as to prevent the horizontal moire remaining image. Such an interlace method is called a motion adaptive deinterlace method. In the motion adaptive deinterlace method, complexity and improvement in the picture quality are greatly changed according to the number of field memory devices used to detect the motion. Two or three field memory devices are generally used.

### SUMMARY OF THE INVENTION

An object of the present invention is to provide a motion adaptive deinterlace method to which several techniques are applied so as to improve a picture quality compared with a conventional method.

The present invention proposes the three techniques as follows.

First, several nonlinear filter techniques are proposed. When an intra-field interpolation is performed with respect to pixels determined as motion pixels, the interpolation is not performed simply using an average value of pixels. Interpolating angles are changed according to directions of adjacent boundaries and the direction of boundaries is stably found.

Second, in order to reduce complexity of hardware, the present invention uses two field memory devices. The present invention prevents images from disappearing after an instant appearance at only one field or prevents a horizontal moire remaining image due to incorrect motion detection by correctly detecting portions having very fast motion.

Third, in case original images are film images, the best deinterlace is achieved by attaching fields corresponding to the same frames in the original images. The present invention proposes a technique that can determine whether or not that the original images are the film image using image itself inputted without any external information. In addition, the present invention proposes a technique that can attach fields existing within the same frames without confusing them with other frames.

Conventional techniques similar to the first technique are disclosed in U.S. Pat. No. 5,929,918 and U.S. Pat. No. 6,262,773. in the U.S. Pat. No. 5,929,918, when the intra-field interpolation is performed since the motion is detected, the interpolation is performed using one line memory device and along three interpolation angles, i.e., a vertical direction, +45° and −45°. In U.S. Pat. No. 6,262,773, although the interpolation is performed along the boundaries of 11 directions, three line memory devices are used. According to the two patents, in case a large number of line memory devices are used, while a circuit design is complicated, the picture quality is improved since the interpolation can be performed along the boundaries of many directions. In case a small number of line memory devices are used, while the hardware is simple, the picture quality is degraded since the direction capable of being interpolated is reduced. The present invention uses only one line memory device and performs the interpolation with respect to boundaries of 7 directions. It is important that possibility of error occurrence is reduced even using one line memory device and the interpolation can be performed lest subjective picture quality should become rough even though there is an error.

Since the second and third techniques apply to special images, the picture quality with respect to ordinary images is not improved. However, in case corresponding images are inputted, the picture quality can be remarkably improved. Particularly, in next digital television era, high-quality movie films are expected to be broadcast in 1920×1080i format that is one of HDTV interlaced scanning formats. In that case, if a reception unit perfectly replays images in the progressive scanning images identical to the original images, a deeper impression can be made. In order to determine the film image, it is expected that it is easy to use three field memory devices. However, the present invention provides a method for determining the film image using two field memory devices. Therefore, the second and third techniques are implemented using two field memory devices.

In an aspect of the present invention, there is provided a method for deinterlacing image signals, which comprises the steps of: (a) extracting motion values with respect to to-be-interpolated pixels using current field data and two-field delayed data; (b) dividing one intra-field pixels into partial images of block unit, and determining whether or not corresponding partial image has a motion using the extracted motion values; (c) determining whether or not the corresponding partial image has a fast motion using the determination result of the step (b) and the determination result of a one-field delayed data; (d) cumulatively counting the determination result of the step (b) for all fields and determining whether or not the current field is a motion field; (e) determining whether or not an inputted image is a film image using data sequentially storing the determination result of the step (b) for several fields; (f) if the inputted image is the film image, synthesizing sequential two fields contained in the same frame to make a progressive scanning image; (g) if the inputted image is not the film image, determining that there is no motion according to the extracted motion values of the respective pixels, and if the inputted image is not a pixel contained in the partial image having the fast motion, performing an intra-field interpolation to obtain an interpolation pixel value; and (h) finding a directionality of boundary of surroundings of to-be-interpolated pixels with respect to the other pixels using pixels of current and just previous lines of a predetermined field, and calculating to-be-interpolated pixel value according to the directionality.

Preferably, the step (a) includes the steps of: (a1) storing the inputted fields into a field memory in turn; (a2) calculating a difference value between pixels disposed at the same position in a field of an inputted current field and a two-field delayed field; and (a3) extracting motion values using difference values of pixels disposed around the to-be-interpolated pixel among the difference values of pixels.

Alternatively, the difference values of the adjacent pixels can use only two pixels vertically disposed at upper/lower portions with respect to the to-be-interpolated pixel. In addition, it is possible to use other pixels including four pixels disposed at upper/lower portions in directions of +45° and −45°.

Alternatively, the motion values can be calculated by an arithmetic average of the difference values between the adjacent pixels. In addition, it can be calculated using a nonlinear filter such as a median filter.

Preferably, the step (b) includes the steps of: (b1) dividing the intra-field pixels into partial images having a block shape of a square; (b2) if the motion value of the respective pixels within the partial image is greater than a predetermined reference value, assigning “1”, and if the motion value is less than the reference value, assigning “0”; and (b3) counting the number of pixels having the “1” within the respective partial images, and if the count value is greater than a predetermined reference value, determining the corresponding pixel as a motion partial image, and if the count value is less than the predetermined reference value, determining the corresponding pixel as a non-motion partial image.

Alternatively, the blocks divided into the partial images can be 1×1 pixel to a maximum entire field. Generally, the blocks consisting of 4×4 pixels or 8×8 pixels can be used.

Alternatively, in addition to the square shape, the partial images can be divided into other figures such as a rectangular shape.

Preferably, the step (c) includes the steps of: (c1) comparing the current field, a just previous field and a motion determination result with respect to the partial images disposed at the same position as the two-field delayed image; and (c2) determining a partial image, in which there is the motion in a middle field (i.e., the just previous field) and there is no motion in the other two determination results, as a fast-motion partial image.

Alternatively, the step (c) includes the steps of: extracting the motion values using only the current field and the just previous field, which are used in a conventional invention; obtaining the determination result with respect to the motion partial images using the motion values; comparing the determination result with the determination result with respect to the partial image having the motion in the same position of the current field and the just previous field, which are used in this invention; determining a partial image, in which it is determined that is no motion in the result of the current field and there is a motion in the other two determination results, as a fast-motion partial image.

Preferably, the step (e) includes the steps of: (e1) assigning a positive integer to the motion field and a negative integer to the non-motion field; (e2) making the assigned integers into an integer sequence in an order of time, and if an output value of a correlation filter having taps corresponding to a multiple of 5 is greater than a predetermined critical value, determining that an original image is the film image, and if the output value is less than the predetermined critical value, determining that the original image is not the film image; and (e3) if the original image is the film image, extracting corresponding synchronization, considering that one frame of the original image is constituted with three or two fields in turn.

Preferably, in the deinterlace with respect to the film image, the frame of the progressive scanning image is made by inserting the current field into the previous or next field within the same frame as the original image in synchronization with the extracted frame.

Preferably, the step (h) includes the steps of: (h1) determining whether the types of boundary adjacent to the to-be-interpolated pixel is a surface boundary in which two surfaces having different brightness are contacted or a line boundary which is a connection type of single pixel having different brightness from the surroundings; (h2) if the type is the surface boundary or the line boundary, obtaining the directionality of corresponding boundary; and (h3) calculating the to-be-interpolated pixel value according to the directionality of boundary.

Preferably, the step (h1) includes the steps of: (h11) selecting M pixels in a left direction and M pixels in a right direction around the to-be-interpolated pixel among pixels disposed at an upper line of the to-be-interpolated pixels, and M pixels in a left direction and M pixels in a right direction around the to-be-interpolated pixel among pixels disposed at a lower line of the to-be-interpolated pixels, and then subtracting the lower line pixel value from the upper line pixel value; (h12) selecting the left N and right N subtraction results according to the directionalities of several angles having a possibility of interpolation among the left M and right M subtraction results, and comparing the results with a predetermined reference value; (h13) selecting a middle pixel among the selected N pixels in the upper line of the to-be-interpolated pixel according to the directionality of boundary having several angles and a middle pixel among the selected N pixels in the lower line of the to-be-interpolated pixel, and calculating an average value of two pixels; (h14) if the absolute values of the left N subtraction results and those of the right N subtraction results are greater than the reference value, determining that there is the line boundary with respect to the directionality of boundary having a possibility of interpolation, and if either the absolute values of the left N subtraction results or those of the right N subtraction results are greater than the reference value and the average value is a middle value between the two pixel values vertical to the to-be-interpolated pixel disposed at the upper and lower lines, and in the other cases, determining that there is neither the surface boundary nor the line boundary with respect to the directionality of boundary having the possibility of interpolation.

Alternatively, the number M can be set to a value greater than “1”. Generally, it is possible to process various directionalities by setting the number to 4 or more. The number N of the subtraction results can be set to a value greater than “1”. Generally, by setting the number N to 3 or more, it is possible to minimize an error when determining the line boundary or the surface boundary.

Preferably, the step of obtaining the directionality of boundary includes the steps of: selecting L pixels in the upper and lower lines of to-be-interpolated pixel according to the directionality of boundary having the possibility of interpolation, calculating an absolute value of a difference between the selected pixels, and calculating a sum of them by setting different weight with respect to the absolute value of the L difference values; and excluding the directions having no surface boundary and line boundary, determining a direction having the minimum value among the calculated sum as the directionality of the surface boundary or the line boundary.

Alternatively, the directionality of boundary having the possibility of interpolation can be selected by differently setting the number of pixels selected in the upper and lower lines of the to-be-interpolated pixel and includes at least 18°, 27°, 45°, 90°, 135°, 153° and 162°.

Alternatively, the number L of pixels selected in the upper and lower lines of the to-be-interpolated pixel can be set to a value greater than “1”. Generally, by setting the number L to 3 or more, it is possible to minimize an error when determining the line boundary or the surface boundary.

Preferably, the step of obtaining the to-be-interpolated pixel value includes the steps of: selecting one pixel in the upper line of the to-be-interpolated pixel according to the directionality of boundary and one pixel in the lower line thereof, and calculating an average value of two pixel; passing the left and right pixel values of the to-be-interpolated pixel and the average value through the median filter; if the directionality of boundary is in the range of 45° to 135° as the finally to-be-interpolated pixel value, selecting the average value of the two pixels, and if the directionality of boundary is less than 45° or greater than 135°, selecting an output of the median filter.

When the image of the interlaced scanning mode is converted into that of the progressive scanning mode, the present invention automatically detects the boundary portions of the several angles in the image signal and interpolates the lines along the boundary portions. The present invention automatically detects the film image of 24 Hz and interpolates it.

The present invention can solve the problems of step phenomenon caused in the boundary portions when the image of the interlaced scanning mode is converted into that of the progressive scanning mode, thereby improving the definition of the boundary portions. In addition, the present invention can solve the problem of the horizontal moire remaining image with respect to partial image having the fast motion. Further, the present invention can improve the picture quality by recovering the film mode image to be close to the original image. Furthermore, the deinterlace circuit having the above function and performance can be implemented with a relatively simple hardware.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram showing an apparatus for deinterlacing video signals in accordance with the present invention;

FIG. 2 is a block diagram of the boundary processing unit shown in FIG. 1;

FIG. 3 is a block diagram of the directionality selection unit shown in FIG. 2;

FIG. 4 is a block diagram of the fast image processing unit shown in FIG. 1;

FIG. 5 is a block diagram of the film image processing unit shown in FIG. 1;

FIGS. 6A to 6G illustrate the concept of the boundary angle in the boundary detection unit shown in FIG. 2;

FIG. 7 illustrates a determination of the boundary types in the boundary detection unit shown in FIG. 2;

FIG. 8A illustrates the concept of a line boundary of a direction of 0° to 90°, which is determined by the boundary detection unit shown in FIG. 2;

FIG. 8B illustrates the concept of a line boundary of a direction of 90° to 180°, which is determined by the boundary detection unit shown in FIG. 2;

FIG. 9A illustrates the concept of a surface boundary of a direction of 0° to 90°, which is determined by the boundary detection unit shown in FIG. 2;

FIG. 9B illustrates the concept of a surface boundary of a direction of 0° to 90°, which is determined by the boundary detection unit shown in FIG. 2;

FIG. 10A illustrates the concept of the directionality detection unit shown in FIG. 3, showing a direction of 0° to 90°;

FIG. 10B illustrates the concept of the directionality detection unit shown in FIG. 3, showing a direction of 90° to 180°;

FIG. 11 illustrates the concept of the film image processing unit shown in FIG. 1;

FIG. 12 illustrates the concept of the correlation filter for explaining the film mode detection unit of FIG. 5; and

FIG. 13 illustrates outputs of the correlation filter in case the field data of the film image are sequentially inputted.

### DETAILED DESCRIPTION OF THE INVENTION

Hereinafter, an apparatus and method for deinterlacing video signals in accordance with the present invention will be described in detail with reference to the accompanying drawings.

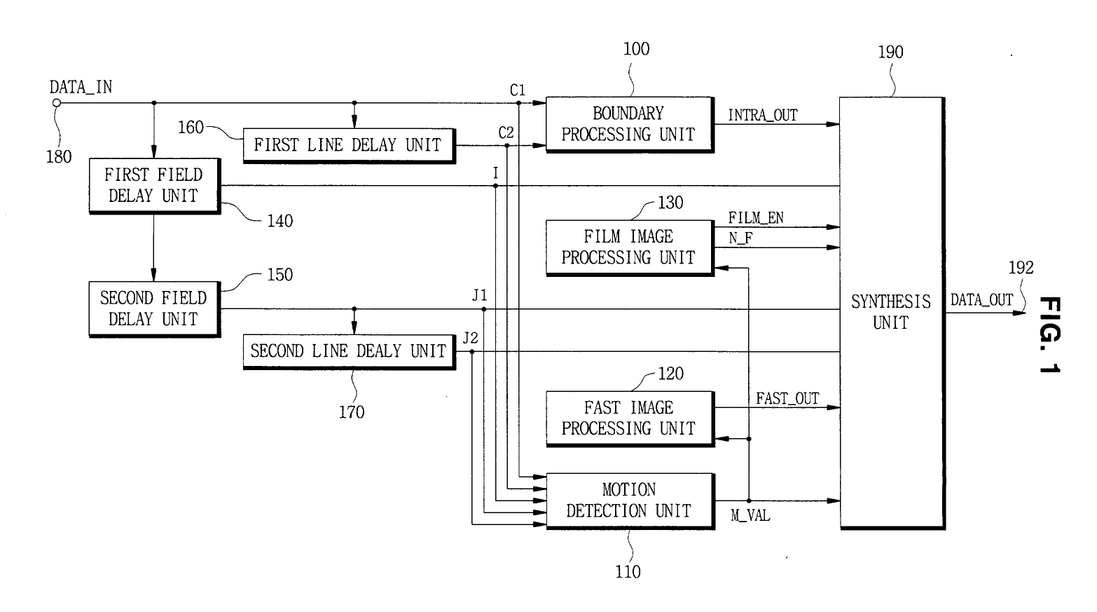

FIG. 1 is a block diagram showing an apparatus for deinterlacing video signals in accordance with the present invention.

Referring to FIG. 1, the apparatus of the present invention includes: a first line delay unit 160 acting as a storage device for delaying and outputting line data of a specific field among a plurality of field image data inputted via an input port 180; a boundary processing unit 100 for obtaining boundary portions of several angles using a line image data C1 of a specific filed inputted via the input port 180 and a one-line delayed image data C2 outputted from the first line delay unit 160 and detecting intra-field data INTRA_OUT to be interpolated according to a directionality of corresponding boundary portion; a first field delay unit 140 for storing image data of a specific field inputted via the input port 180; a second field delay unit 150 for storing image data inputted the first field delay unit 140 based on field units; a second line delay unit 170 for storing image data J1 of a specific field inputted from the second field delay unit 150 based on line units; a motion detection unit 110 for detecting motions using the image data C of a current field, the delayed image data I and J1 outputted from the first and second field delay units 140 and 150 and the delayed image data C2 and J2 outputted from the first and second line delay units 160 and 170 and outputting a motion value M_VAL; a fast image processing unit 120 for detecting a fast-motion image using the motion value M_VAL and a one-field delayed motion value PRE_M_VAL; a film image processing unit 130 for detecting film image according to the motion value M_VAL inputted from the motion detection unit 110 and determining intra-field data to be interpolated by the detected film image; and a synthesis unit 190 for selectively interpolating the to-be-interpolated intra-field data INTRA_OUT obtained by the boundary processing unit 100, the previous field image data I outputted from the first field delay unit 140, or two-field delayed image data J1 and J2, based on the motion value M_VAL inputted from the motion detection unit 110, a fast-motion signal FAST_EN inputted from the fast image processing unit 120, a next field signal N_F and a film mode signal FILM_EN inputted from the film image processing unit 130, and outputting the interpolated data via an output port 192.

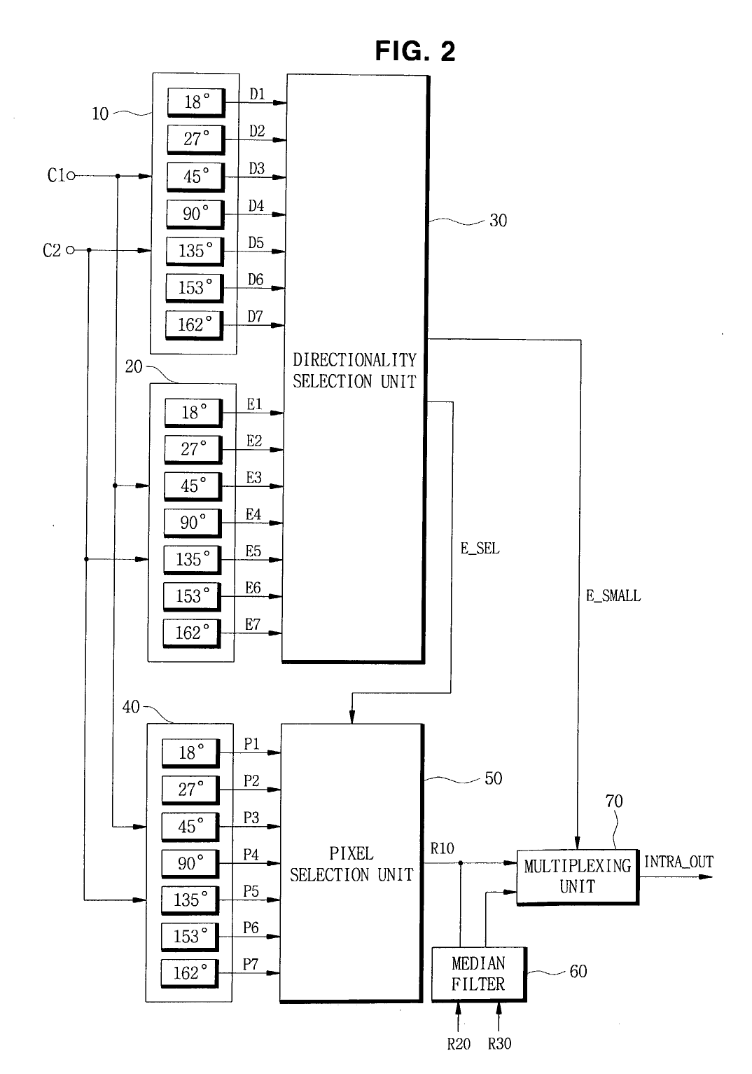

As shown in FIG. 2, the boundary processing unit 100 includes: a direction-based difference value generation unit 10 for outputting difference values D1 to D7 with respect to directionality of boundary in several angles having a possibility of interpolation using the line image data C1 of the current field and the one-line delayed image data C2 respectively inputted from the input port 180 and the first line delay unit 160; a boundary detection unit 20 for detecting whether there is a surface boundary or a line boundary using the line image data C1 of the current filed and the one-line delayed image data C2 and outputting boundary presence signals E1 to E7; a directionality selection unit 30 for determining a directionality of boundary to be finally interpolated using the line image data C1 of the current field, the one-line delayed image data C2, the difference values D1 to D7 with respect to the directionality of boundary in several angles inputted from the direction-based difference value generation unit 10, and the boundary presence signals E1 to E7 inputted from the boundary detection unit 20, and outputting a boundary direction selection value E_SEL and a boundary angle magnitude signal E_SMALL; a direction-based average value generation unit 40 for outputting average values P1 to P7 of pixels with respect to the directionality of boundary in several angles having the possibility of interpolation using the line image data C1 of the current field and the one-line delayed image data; a pixel selection unit 50 for selecting and outputting a to-be-interpolated current pixel value R10 among the average values P1 to P7 of pixels with respect to the directionality of boundary in several angles inputted from the direction-based average value generation unit 40 according to the result of the directionality selection unit 30; a median filter 60 for removing noise components using the to-be-interpolated current pixel value R10, an interpolated previous pixel value R20 and a to-be-interpolated next pixel value R30 and performing a grouping operation; and a multiplexing unit 70 for selecting one of a pixel value R40 inputted from the median filter 60 and the to-be-interpolated current pixel value R10 selected by the pixel selection unit 50, and outputting a to-be-interpolated intra-field data INTRA_OUT to the synthesis unit 190. The interpolated previous pixel value R20 represents a left pixel value of the to-be-interpolated current pixel R10 and the left pixel value is obtained through the above-described process in the boundary processing unit 100. The to-be-interpolated next pixel value R30 represents a right pixel value of the to-be-interpolated current pixel R10 and the right pixel value is obtained through the direction-based difference value generation unit 10, the boundary detection unit 20, the directionality selection unit 30, the direction-based average value generation unit 40 and the pixel selection unit 50 in the boundary processing unit 100.

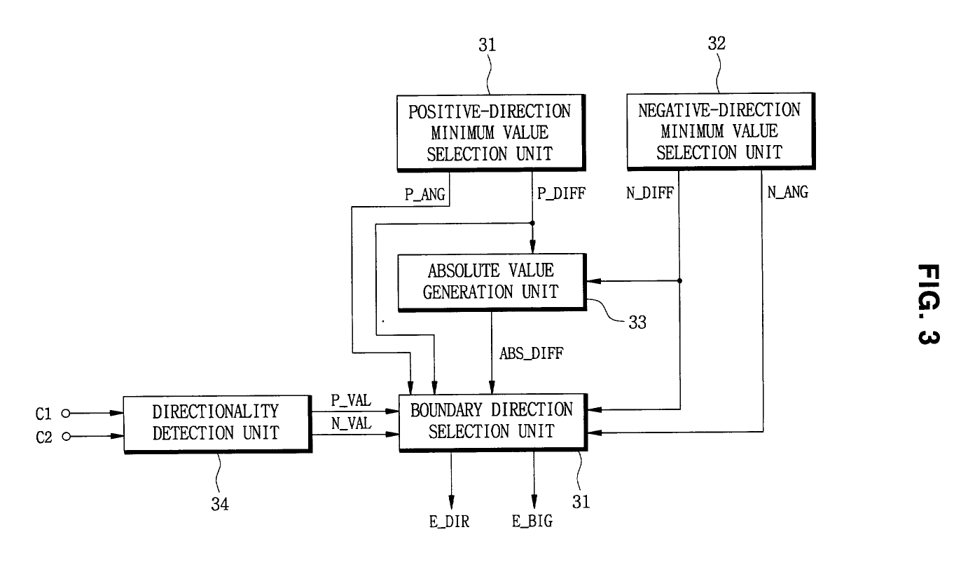

In addition, as shown in FIG. 3, the directionality selection unit 30 includes: a positive-direction minimum value selection unit 31 for selecting a minimum value among the directionality of 18°, 27°, 45° and 90° using the difference values D1 to D4 with respect to a positive direction (i.e., angles of 0° to 90° in FIG. 2) and the boundary presence signals E1 to E4 with respect to the positive direction, and outputting a positive-direction minimum difference value P_DIFF and a positive-direction angle value P_ANG; a negative-direction minimum value selection unit 32 for selecting a minimum value among the directionality of 90°, 135°, 153° and 162° using the difference values D4 to D7 with respect to a negative direction (i.e., angles of 90° to 180° in FIG. 2) and the boundary presence signals E4 to E7 with respect to the negative direction, and outputting a negative-direction minimum difference value N_DIFF and a negative-direction angle value N_ANG; an absolute value generation unit 33 for obtaining and outputting an absolute value ABS_VAL of difference between the absolute value of the positive-direction minimum difference value P_DIFF and that of the negative-direction minimum difference value N_DIFF, which are inputted from the positive-direction minimum value selection unit 31 and the negative-direction minimum value selection unit 32, respectively; a directionality detection unit 34 for obtaining and outputting a positive direction value P_VAL and a negative direction value N_VAL, which represent an entire directionality of surroundings of to-be-interpolated pixels, using the line image data C1 of the current field and the one-line delayed image data C2; and a boundary direction selection unit 35 for selecting one of the positive-direction minimum difference value P_DIFF and the negative-direction minimum difference value N_DIFF, which are respectively inputted from the positive-direction minimum value selection unit 31 and the negative-direction minimum value selection unit 32, using the positive direction value P_VAL, the negative direction value N_VAL, the positive-direction minimum difference value P_DIFF, the positive-direction angle value P_ANG, the negative-direction minimum difference value N_DTFF, the negative-direction angle value N_ANG, the absolute value ABS_DIFF and a predetermined boundary reference value TH_EDGE, for determining the directionality of corresponding boundary as the directionality of final boundary to thereby obtain a boundary direction selection value E_SEL and the boundary angle magnitude signal E_SMALL, and for outputting them to the pixel selection unit 50.

Further, using the image data C1 and C2 of the current field, the one-field delayed image data I and the two-field delayed image data J1 and J2, the motion detection unit 110 recognizes a presence of motion based on pixel units by comparing the current field with the two-field delayed image data. IF there is the motion, the motion detection unit 110 outputs the motion value M_VAL of a high level. On the contrary, if there is not the motion, the motion detection unit 110 outputs the motion value M_VAL of a low level.

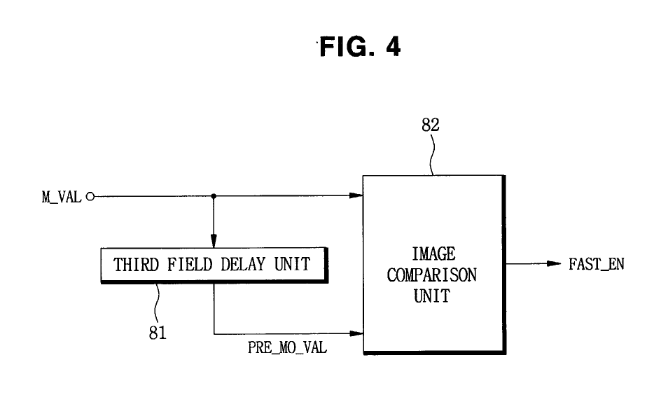

As shown in FIG. 4, the fast image processing unit 120 includes: a third field delay unit 81 for storing the motion value M_VAL with respect to all pixels of one field inputted from the motion detection unit 110; and a motion comparison unit 82 for detecting the motion by comparing the motion value M_VAL inputted from the motion detection unit 110 with the one-field delayed motion value PRE_M_VAL outputted from the third field delay unit 81 based on pixel units, and for generating the fast-motion signal FAST_EN according to the detection result to the synthesis unit 190.

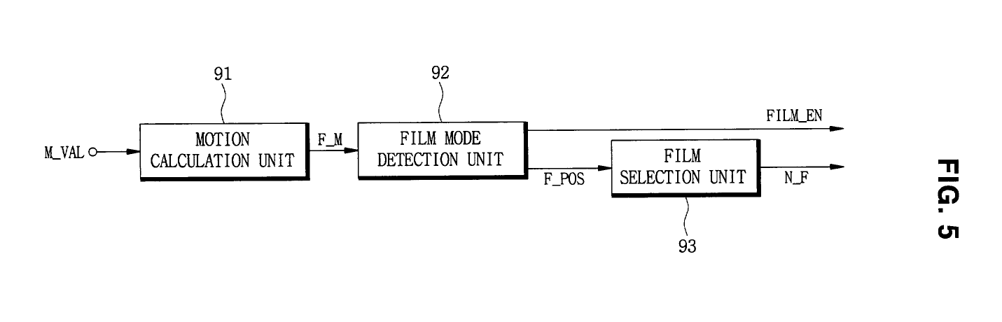

As shown in FIG. 5, the film image processing unit 130 includes: a motion calculation unit 91 for counting the number of pixels moving in the current field using the motion value M_VAL of each pixel detected by the motion detection unit 110, for detecting the motion of the current field by comparing the counted number with a reference value TH_MOTION, and for outputting a field motion signal F_M; a film mode detection unit 92 for setting a weight between a moving field and a non-moving field and detecting whether or not an original image is a film image according to the field motion signal F_M detected by the motion calculation unit 91, and for outputting a film mode signal FILM_EN and a field position value F_POS; and a field selection unit 93 for determining and outputting a to-be-interpolated next field value N_F according to the detected field position value F_POS.

Hereinafter, a preferred embodiment of the present invention configured as above will be described in detail with reference to FIGS. 1 to 13.

As shown in FIG. 1, if an image data DATA_IN is inputted via the input port 180, the first line delay unit 160 stores the inputted image data based on line units and then provides it to the boundary processing unit 100. The boundary processing unit 100 scans the boundaries of several angles using the line image data C1 of a specific field inputted via the input port 180 and the one-line delayed image data J2 outputted from the first line delay unit 160, and outputs the intra-field data INTRA_OUT to be interpolated according to the directionality of corresponding boundary.

As shown in FIG. 2, the boundary processing unit 100 includes the direction-based difference value generation unit 10, the boundary detection unit 20, the directionality selection unit 30, the direction-based average value generation unit 40, the pixel selection unit 50, the median filter 60 and the multiplexing unit 70.

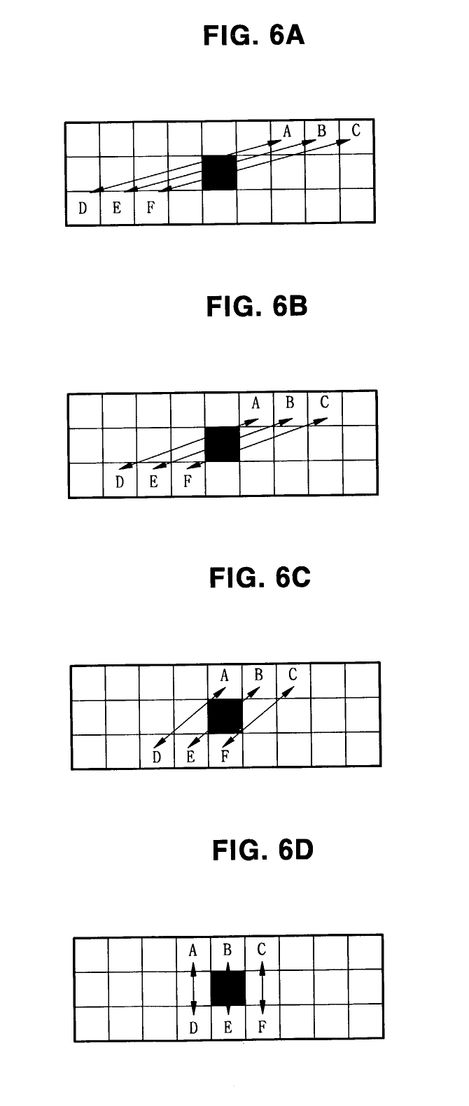

As shown in FIGS. 6A to 6G, using the line image data C1 of the current field and the one-line delayed image data C2 which are respectively inputted from the input port 180 and the first line delay unit 160, the direction-based difference value generation unit 10 selects the directionality of boundaries in several angles of 18°, 27°, 45°, 90°, 135°, 153°, 162°, etc., and calculates the difference values D1 to D7 with respect to directionality of each boundary. Here, the difference value D1 to D7 with respect to the directionality of each boundary can be obtained using a following equation.

difference value(D)={ABS(A−D)+2×ABS(B−E)+ABS(C−F)}/4

where, as shown in FIGS. 6A to 6G, A, B and C present pixel data of line disposed above a to-be-interpolated line, and D, E and F represent pixel data of line disposed below a to-be-interpolated line.

The boundary detection unit 20 determines the presence of surface boundary or line boundary with respect to the directionality of several angles of 18°, 27°, 45°, 90°, 135°, 153°, 162°, etc. If there is the surface boundary or the line boundary, the boundary detection unit 20 outputs the boundary presence signals E1 to E7 of high level, and if there is not the surface boundary or the line boundary, the boundary detection unit 20 outputs the boundary presence signals E1 to E7 of low level. Here, if the directionality of boundary is close to a vertical direction, i.e., with respect to the directionality of 45°, 90° and 135° as shown in FIGS. 6C, 6D and 6E, there is almost no possibility that an interpolation is incorrectly performed due to recognition error of the presence of the surface boundary or the line boundary and corresponding slope directions. However, if the directionality of boundary is smooth in a horizontal direction, i.e., with respect to the directionality of 18°, 27°, 153° and 162° as shown in FIGS. 6A, 6B, 6F and 6G, spots or saw-tooth shaped images may be caused by incorrectly interpolating boundaries because of recognition error of the presence of the surface boundary or the line boundary and corresponding slope directions, so that a picture quality is deteriorated. Accordingly, with respect to the directionality of 18°, 27°, 153° and 162° as shown in FIGS. 6A, 6B, 6F and 6G, the boundary detection unit 20 correctly detects the presence of the surface boundary or the line boundary so that the incorrect interpolation cannot be performed at following steps.

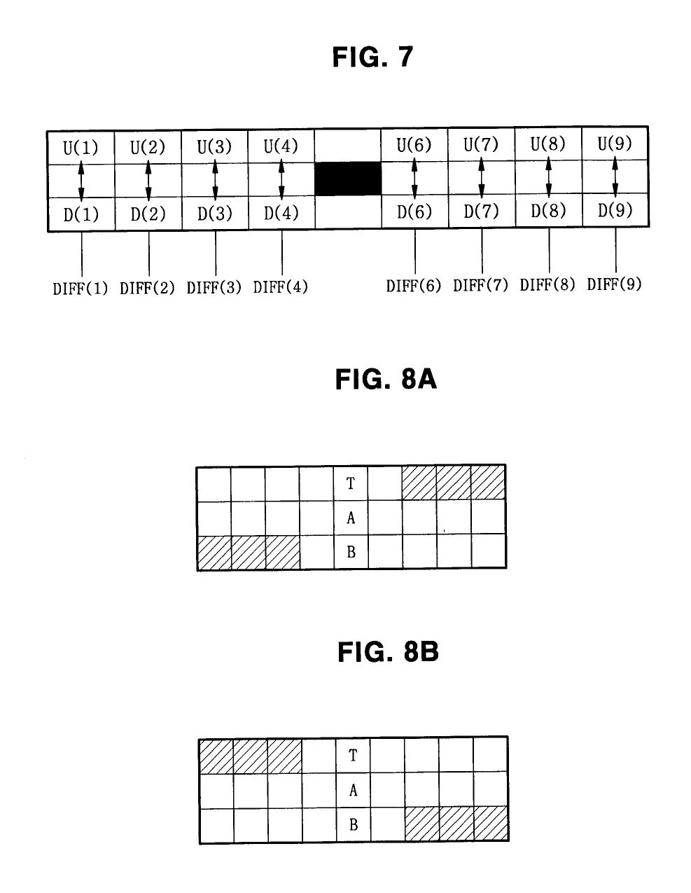

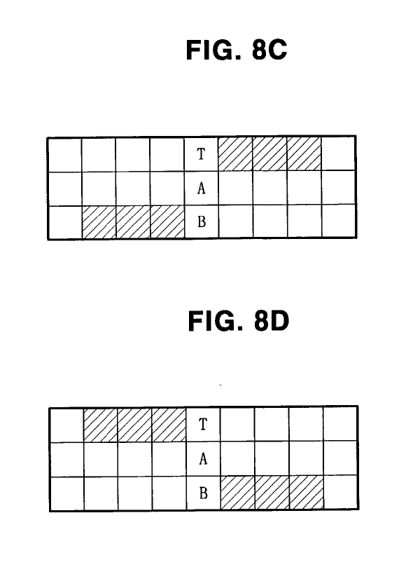

According to a method for detecting the presence of the surface boundary or the line boundary with respect to the directionality of 18°, 27°, 153° and 162° in which the directionality of boundaries is smooth in a horizontal direction as shown in FIGS. 6A, 6B, 6F and 6G, the presence of boundary can be detected by determining whether the boundary portions disposed around the to-be-interpolated pixels is the line boundary as shown in FIGS. 8A to 8D or the surface boundary as shown in FIGS. 9A to 9H using difference values DIFF1 to DIFF8 and average values AVE1 to AVE4 between pixels of line disposed above the to-be-interpolated pixels and pixels of line disposed below the to-be-interpolated pixels. Here, the difference values DIFF1 to DIFF8 and the average values AVE1 to AVE4 can be obtained using a following equation.

DIFF(n)=ABS{U(n)−D(n)}, n=1, 2, 3, 4, 5, 6, 7, 8

AVE1={U(8)+D(2)}/2

AVE2={U(7)+D(3)}/2

AVE3={U(3)+D(7)}/2

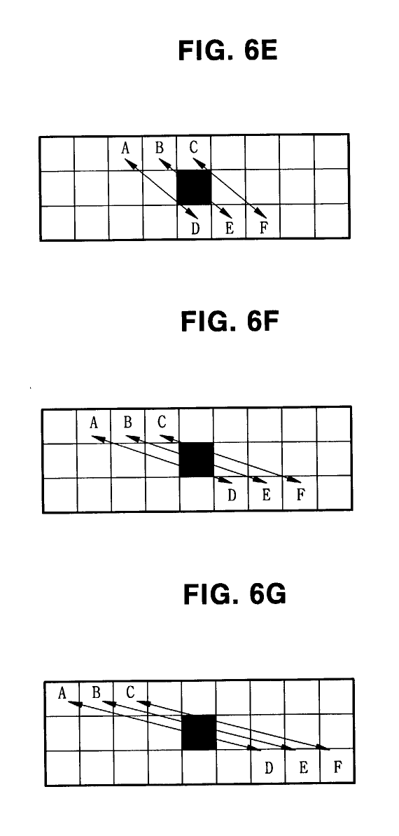

AVE4={U(2)+D(8)}/2

where, as shown in FIG. 7, U(n) represents pixel data of line disposed above to-be-interpolated pixels, and D(n) represents pixel data of line disposed below to-be-interpolated pixels.

In a method for detecting the presence of the surface boundary or the line boundary with respect to the directionality of 18°, it is determined that there is the line boundary with respect to the directionality of 18° as shown in FIG. 8A, if the difference values DIFF1, DIFF2, DIFF7 and DIFF8 are greater than the predetermined reference value TH_DIFF and the difference values DIFF3 and DIFF6 are greater than half the reference value TH_DIFF. In addition, it is determined that there is the surface boundary with respect to the directionality of 18° as shown in FIG. 9A, if the difference values DIFF1 and DIFF2 are greater than the reference value TH_DIFF, the difference value DIFF3 is greater than half the reference value TH_DIFF, the difference values DIFF6, DIFF7 and DIFF8 are smaller than the reference value TH_DIFF, and the average value AVE1 of the pixel of upper line disposed above the to-be-interpolated pixel and that of lower line disposed below the to-be-interpolated pixel are between a pixel data value T of upper line and a pixel data value B of lower line. Further, it is determined that there is the surface boundary with respect to the directionality of 18° as shown in FIG. 9B, if the difference values DIFF7 and DIFF8 are greater than the reference value TH_DIFF, the difference value DIFF6 is greater than half the reference value TH_DIFF, the difference values DIFF1, DIFF2 and DIFF3 are smaller than the reference value TH_DIFF, and the average value AVE1 of the pixel of upper line disposed above the to-be-interpolated pixel and that of lower line disposed below the to-be-interpolated pixel are between a pixel data value T of upper line and a pixel data value B of lower line.

In a method for detecting the presence of the surface boundary or the line boundary with respect to the directionality of 27°, it is determined that there is the line boundary with respect to the directionality of 27° as shown in FIG. 8A, if the difference values DIFF2, DIFF3, DIFF6 and DIFF7 are greater than the predetermined reference value TH_DIFF and the difference values DIFF4 and DIFF5 are greater than half the reference value TH_DIFF. In addition, it is determined that there is the surface boundary with respect to the directionality of 27° as shown in FIG. 9C, if the difference values DIFF2 and DIFF3 are greater than the reference value TH_DIFF, the difference value DIFF4 is greater than half the reference value TH_DIFF, the difference values DIFF5, DIFF6 and DIFF7 are smaller than the reference value TH_DIFF, and the average value AVE2 of the pixel of upper line disposed above the to-be-interpolated pixel and that of lower line disposed below the to-be-interpolated pixel are between a pixel data value T of upper line and a pixel data value B of lower line. Further, it is determined that there is the surface boundary with respect to the directionality of 27° as shown in FIG. 9D, if the difference values DIFF6 and DIFF7 are greater than the reference value TH_DIFF, the difference value DIFF5 is greater than half the reference value TH_DIFF, the difference values DIFF2, DIFF3 and DIFF4 are smaller than the reference value TH_DIFF, and the average value AVE2 of the pixel of upper line disposed above the to-be-interpolated pixel and that of lower line disposed below the to-be-interpolated pixel are between a pixel data value T of upper line and a pixel data value B of lower line.

In a method for detecting the presence of the surface boundary or the line boundary with respect to the directionality of 153°, it is determined that there is the line boundary with respect to the directionality of 153° as shown in FIG. 8A, if the difference values DIFF2, DIFF3, DIFF6 and DIFF7 are greater than the predetermined reference value TH_DIFF and the difference values DIFF4 and DIFF5 are greater than half the reference value TH_DIFF. In addition, it is determined that there is the surface boundary with respect to the directionality of 153° as shown in FIG. 9E, if the difference values DIFF2 and DIFF3 are greater than the reference value TH_DIFF, the difference value DIFF4 is greater than half the reference value TH_DIFF, the difference values DIFF5, DIFF6 and DIFF7 are smaller than the reference value TH_DIFF, and the average value AVE3 of the pixel of upper line disposed above the to-be-interpolated pixel and that of lower line disposed below the to-be-interpolated pixel are between a pixel data value T of upper line and a pixel data value B of lower line. Further, it is determined that there is the surface boundary with respect to the directionality of 153° as shown in FIG. 9F, if the difference values DIFF6 and DIFF7 are greater than the reference value TH_DIFF, the difference value DIFF5 is greater than half the reference value TH_DIFF, the difference values DIFF2, DIFF3 and DIFF4 are smaller than the reference value TH_DIFF, and the average value AVE3 of the pixel of upper line disposed above the to-be-interpolated pixel and that of lower line disposed below the to-be-interpolated pixel are between a pixel data value T of upper line and a pixel data value B of lower line.

In a method for detecting the presence of the surface boundary or the line boundary with respect to the directionality of 162°, it is determined that there is the line boundary with respect to the directionality of 162° as shown in FIG. 8A, if the difference values DIFF1, DIFF2, DIFF7 and DIFF8 are greater than the predetermined reference value TH_DIFF and the difference values DIFF3 and DIFF6 are greater than half the reference value TH_DIFF. In addition, it is determined that there is the surface boundary with respect to the directionality of 162° as shown in FIG. 9G, if the difference values DIFF1 and DIFF2 are greater than the reference value TH_DIFF, the difference value DIFF3 is greater than half the reference value TH_DIFF, the difference values DIFF6, DIFF7 and DIFF8 are smaller than the reference value TH_DIFF, and the average value AVE4 of the pixel of upper line disposed above the to-be-interpolated pixel and that of lower line disposed below the to-be-interpolated pixel are between a pixel data value T of upper line and a pixel data value B of lower line. Further, it is determined that there is the surface boundary with respect to the directionality of 162° as shown in FIG. 9H, if the difference values DIFF7 and DIFF8 are greater than the reference value TH_DIFF, the difference value DIFF6 is greater than half the reference value TH_DIFF, the difference values DIFF1, DIFF2 and DIFF3 are smaller than the reference value TH_DIFF, and the average value AVE4 of the pixel of upper line disposed above the to-be-interpolated pixel and that of lower line disposed below the to-be-interpolated pixel are between a pixel data value T of upper line and a pixel data value B of lower line.

According to the above-described method, the boundary detection unit 20 detects the presence of boundary with respect to the directionality of 18°, 27°, 153° and 162° as shown in FIGS. 6A, 6B, 6F and 6G. If there is the surface boundary or the line boundary, the boundary detection unit 20 outputs the boundary presence signals E1, E2, E6 and E7 of high level with respect to corresponding directionality. In the other cases, it is determined that there are no boundaries with respect to the directionality of 18°, 27°, 153° and 162°, so that the boundary detection unit 20 outputs the boundary presence signals E1, E2, E6 and E7 of low level with respect to corresponding directionality. In addition, it is once assumed that there is the boundary with respect to the directionality of 45°, 90° and 135°, so that the boundary detection unit 20 provides the boundary presence signals E3, E4 and E5 of high level to the direction selection unit 30.

As shown in FIG. 3, the direction selection unit 30 includes the positive-direction minimum value selection unit 31, the negative-direction minimum value selection unit 32, the absolute value generation unit 33, the directionality detection unit 34, and the boundary direction selection unit 35.

The positive-direction minimum value selection unit 31 selects the directionality of the most suitable boundary among the directionality of angles of 0° to 90°. At this time, among the difference values D1 to D4 inputted from the direction-based difference value generation unit 10, the positive-direction minimum value selection unit 31 ignores the difference value with respect to the directionality of a low level among the boundary presence signals E1 to E4 inputted from the boundary detection unit 20. Then the positive-direction minimum value selection unit 31 selects the smallest absolute value among the other signals to output it as the positive-direction minimum difference value P_DIFF, and outputs the corresponding positive direction angle value P_ANG. Here, the positive direction value P_ANG is expressed by integers, i.e., 1, 2, 3 and 4. The integer “1” means that the directionality of 18° is selected, and the integers “2, 3 and 4” mean that the directionalities of 27°, 45° and 90° are respectively selected.

The negative-direction minimum value selection unit 32 selects the directionality of the most suitable boundary among the directionality of angles of 90° to 180°. At this time, among the difference values D4 to D7 inputted from the direction-based difference value generation unit 10, the negative-direction minimum value selection unit 32 ignores the difference value with respect to the directionality of a low level among the boundary presence signals E4 to E7 inputted from the boundary detection unit 20. Then the negative-direction minimum value selection unit 32 selects the smallest absolute value among the other signals to output it as the negative-direction minimum difference value N_DIFF, and outputs the corresponding negative direction angle value N_ANG. Here, the negative direction value N_ANG is expressed by integers, i.e., 4, 5, 6 and 7. The integer “4” means that the directionality of 90° is selected, and the integers “5, 6 and 7” mean that the directionalities of 135°, 153° and 162° are respectively selected.

The absolute value generation unit 33 obtains the absolute value ABS_DIFF of the difference between absolute values of the positive-direction minimum difference value P_DIFF and the negative-direction minimum difference value N_DIFF, which are inputted from the positive-direction minimum value selection unit 31 and the negative-direction minimum value selection unit 32, respectively. Then, the absolute value generation unit 33 provides the obtained absolute value ABS_DIFF to the boundary direction selection unit 35.

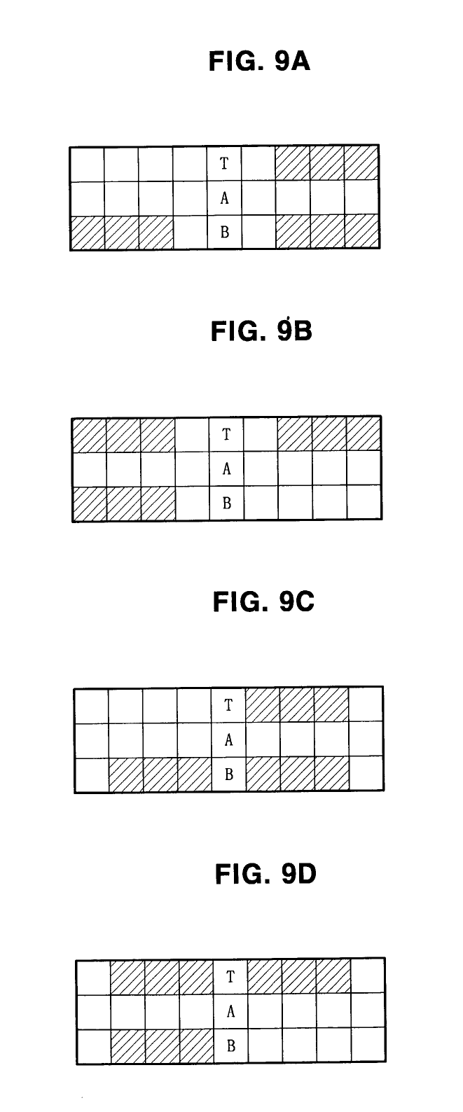

Using the line image data C1 of the current field inputted via the input port 180 and the one-line delayed image data C2 outputted from the first line delay unit 160, the directionality detection unit 34 obtains the positive direction value P_VAL with respect to the positive direction having the angles of 0° to 90° and the negative direction value N_VAL with respect to the negative direction having the angles of 90° to 180°. Then, the directionality detection unit 34 provides the obtained positive and negative direction values P_VAL and N_VAL to the boundary direction selection unit 35. As shown in FIGS. 10A and 10B, the directionality detection unit 34 generates respectively the positive direction value P_VAL and the negative direction value N_VAL with respect to the positive direction and the negative direction according to a following equation.

positive direction value (P_VAL)={ABS(A−E)+ABS(B−F)+ABS(C−G)+ABS(D−H)}/4

negative direction value (N_VAL)={ABS(A′−E′)+ABS(B′−F′)+ABS(C′−G′)+ABS(D′−H′)}/4

where, as shown in FIGS. 10A and 10B, (A, B, C, D) and (A′, B′, C′, D′) represent pixel data of line disposed above a to-be-interpolated line, and (E, F, G, H) and (E′, F′, G′, H′) represent pixel data of line disposed below A to-be-interpolated line.

Using the positive-direction minimum difference value P_DIFF, the negative-direction minimum difference value N_DIFF, the positive-direction angle value P_ANG, the negative-direction angle value N_ANG, the absolute value ABS_DIFF, the positive direction value P_VAL and the negative direction value N_VAL, the boundary direction selection unit 35 determines the directionality of final boundary and respectively provides the final boundary direction selection value E_SEL and the boundary angle magnitude signal E_SMALL to the pixel selection unit 50 and the multiplexing unit 70, which are shown in FIG. 2. Here, the boundary direction selection value E_SEL is expressed by integers of 1 to 7. The integer “1” means that the direction of 18° is selected as the directionality of the final boundary, and the integers “2 to 7” mean that the directions of 27°, 45°, 90°, 135°, 153° and 162° are respectively selected as the directionality of the final boundary. If the directionality of the final boundary selects horizontally smooth angles, e.g., 18°, 27°, 135° or 162°, the boundary angle magnitude signal E_SMALL of a high level is outputted. If the directionality of the final boundary selects angles close to the vertical, e.g., 45°, 90° or 135°, the boundary angle magnitude signal E_SMALL of a low level is outputted.

If the absolute values of the positive-direction minimum difference value P_DIFF and the negative-direction minimum difference value N_DIFF are simultaneously less than the boundary reference value TH_EDGE, it is the case that the directionality of boundary can have both the positive direction and the negative direction. Therefore, the boundary direction selection unit 35 compares the absolute value ABS_DIFF obtained by the absolute value generation unit 33 with the absolute reference value TH_VAL. If the absolute value ABS_DIFF is less than the absolute reference value TH_VAL, since there is a possibility that both the positive direction and the negative direction can be the directionality of boundary, the boundary direction selection unit 35 must find the correct directionality once again. In addition, the boundary direction selection unit 35 compares the absolute value of the positive direction value P_VAL with that of the negative direction value N_VAL. If the absolute value of the positive direction value P_VAL is greater than that of the negative direction value N_VAL, it is determined that there is the directionality of boundary between 0° and 90°. Meanwhile, if the absolute value of the negative direction value N_VAL is greater than that of the positive direction value P_VAL, it is determined that there is the directionality of boundary between 90° and 180°. If the absolute values of the positive-direction minimum difference value P_DIFF and the negative-direction minimum difference value N_DIFF are simultaneously less than the boundary reference value TH_EDGE and the absolute value ABS_DIFF is greater than the absolute reference value TH_VAL, since it means that the positive directionality is certainly different from the negative directionality, a direction corresponding to a small value among the absolute values of the positive-direction minimum difference value P_DIFF and the negative-direction minimum difference value N_DIFF is determined as a final direction of boundary. If the absolute value of the positive-direction minimum difference value P_DIFF is less than the boundary reference value TH_EDGE and the absolute value of the negative-direction minimum difference value N_DIFF is greater than the boundary reference value TH_EDGE, the positive direction is determined as a final direction of boundary. If the absolute value of the positive-direction minimum difference value P_DIFF is greater than the boundary reference value TH_EDGE and the absolute value of the negative-direction minimum difference value N_DIFF is less than the boundary reference value TH_EDGE, the negative direction is determined as a final direction of boundary. If all the absolute values of the positive-direction minimum difference value P_DIFF and the negative-direction minimum difference value N_DIFF are greater than the boundary reference value TH_EDGE, it is determined that there is no slope of the positive direction or the negative direction and thus the pixel selection unit 50 of FIG. 2 is allowed to achieve an interpolation of a vertical direction. If there is the final direction of boundary between 0° to 90°, the positive direction angle value P_ANG is outputted as the boundary direction selection value E_SEL. If there is the final direction of boundary between 90° to 180°, the negative direction angle value N_ANG is outputted as the boundary direction selection value E_SEL. If there is no slope of the positive direction or the negative direction in the final direction of boundary, the boundary direction selection value E_SEL is outputted as the integer “4”. In addition, if the boundary direction selection value E_SEL is one of 1, 2, 6 and 7, the boundary angle magnitude signal E_SMALL of a high level is outputted. If the boundary direction selection value E_SEL is one of 3, 4 and 5, the boundary angle magnitude signal E_SMALL of a low level is outputted.

As shown in FIGS. 6A to 6G, using the line image data C1 of the current field and the one-line delayed image data C2, which are respectively inputted from the input port 180 and the first line delay unit 160, the direction-based average value generation unit 40 selects the directionality of boundary in several angles of 18°, 27°, 45°, 90°, 135°, 153° and 162° and obtains the average values P1 to P7 with respect to the directionalities of the respective boundaries using a following equation.

average value (P) of pixel=(B+E)/2

where, as shown in FIGS. 6A to 6G, “B” represents a pixel data of line disposed above a to-be-interpolated line, and “E” represents a pixel data of line disposed below a to-be-interpolated line.

The pixel selection unit 50 selects one of the average values P1 to P7 with respect to several directionalities, which are inputted from the direction-based average value generation unit 40, as the to-be-interpolated pixel value R10 according to the final direction of boundary inputted from the directionality selection unit 30. Here, if the boundary direction selection value E_SEL inputted from the boundary direction selection unit 35 is the integer “1”, the average value P1 with respect to the direction of 18° is selected as the to-be-interpolated pixel value R10. In the same manner, if the boundary direction selection value E_SEL is the integers “2, 3, 4, 5, 6, and 7”, the average values P2 to P7 with respect to the directions of 27°, 45°, 90°, 135°, 153° and 162° are respectively selected as the to-be-interpolated pixel value R10.

Using the to-be-interpolated current pixel value R10, the interpolated previous pixel value R20 and the to-be-interpolated next pixel value R30, the median filter 60 removes noise components and provides the grouping result R40 to the multiplexing unit 70. Here, the interpolated previous pixel value R20 represents a left pixel value of the to-be-interpolated current pixel R10 and the left pixel value is obtained through the above-described process in the boundary processing unit 100. The to-be-interpolated next pixel value R30 represents a right pixel value of the to-be-interpolated current pixel R10 and the right pixel value is obtained through the direction-based difference value generation unit 10, the boundary detection unit 20, the directionality selection unit 30, the direction-based average value generation unit 40 and the pixel selection unit 50 in the boundary processing unit 100.

The multiplexing unit 70 selects one of the to-be-interpolated pixel value R10 and the grouping result R40, in which noise components are removed by the median filter 60, according to the boundary angle magnitude signal E_SMALL inputted from the boundary direction selection unit 35 and outputs the selected value as the to-be-interpolated intra-field data INTRA_OUT according to the final result of the boundary processing unit 100, i.e., the directionality of boundary. Here, the to-be-interpolated pixel value R10 is selected among the average values P1 to P7 with respect to the several directionalities by the pixel selection unit 50.

If the boundary angle magnitude signal E_SMALL is a high level, it means that the directionality of boundary is horizontally smooth angles, i.e., 18°, 27°, 153° and 162°. At this time, since there is a possibility that an error occurs when selecting the directionality, the multiplexing unit 70 selects the grouping result R40 as the final output. If the boundary angle magnitude signal E_SMALL is a low level, it means that the directionality of boundary is the angles of 45°, 90° and 135° which are close to the vertical direction. At this time, since there is almost no possibility that an error occurs when selecting the directionality, the multiplexing unit 70 selects the to-be-interpolated pixel value R10 as the final output. Here, the to-be-interpolated pixel value R10 is selected among the average values P1 to P7 with respect to the several directionalities by the pixel selection unit 50.

Meanwhile, as shown in FIG. 4, the fast image processing unit 120 of FIG. 1 includes the third field delay unit 81 and the motion comparison unit 82. The motion detection unit 110 compares the motion value M_VAL with the one-field delayed motion value PRE_M_VAL and detects whether or not the current pixel has a fast motion. If there is the fast motion, the fast motion signal FAST_ON of a high level is outputted. If there is no fast motion, the fast motion signal FAST_ON of a low signal is outputted. The motion value M_VAL and the one-field delayed motion value PRE_M_VAL are motion information of the same position having a difference of one field.

If an interlaced scanning image having the fast motion is inputted, it is difficult to determine whether or not there is the fast motion based on pixel units by using only the image data of the current field and the one-field delayed image data. Therefore, image data of three fields are generally used. In the present invention, however, the fast motion is detected from the image, which is inputted with only memory of two fields, using the motion value M_VAL inputted from the motion detection unit 110, on the basis of pixel units.

The third field delay unit 81 stores the motion value M_VAL inputted from the motion detection unit 110 by one field, and provides the one-field delayed motion value PRE_M_VAL to the motion comparison unit 82.

The motion comparison unit 82 compares the motion value M_VAL inputted from the motion detection unit 110 with the one-field delayed motion value PRE_M_VAL inputted from the third field delay unit 81 and determines whether or not there is the fast motion based on pixel units. If the motion value M_VAL in the current field is a low level and the one-field delayed motion value PRE_M_VAL is a high level, i.e., if there is no motion in the current field and there is the motion in the previous field, it is determined that there is the fast motion, so that the fast motion signal FAST_EN of a high level is outputted. In the other cases, it is determined that there is no fast motion, so that the fast motion signal FAST_EN of a low signal is outputted.

The fast motion signal FAST_EN outputted from the fast image processing unit 120 is provided to the synthesis unit 190 of FIG. 1. When the to-be-interpolated pixel is obtained according to the fast motion signal FAST_EN, the synthesis unit 190 determines whether it uses the previous field data or the intra-field interpolation data INTRA_OUT inputted from the boundary processing unit 100. At this time, if the fast motion signal FAST_EN is a high level, it means that the corresponding pixel is a pixel having the fast motion. Therefore, the intra-field interpolation data INTRA_OUT inputted from the boundary processing unit 100 is outputted as the to-be-interpolated data. As a result, when the image of the interlaced scanning mode is converted into that of the progressive scanning mode, a problem that an occurrence of horizontal moire remaining image caused by time difference between two fields can be solved, thereby improving a definition of the boundary portion and a picture quality.

Meanwhile, as shown in FIG. 5, the film image processing unit 130 of FIG. 1 includes the motion calculation unit 91, the film mode detection unit 92 and the field selection unit 93. The film image processing unit 130 detects whether or not the original image is the film image according to the motion value M_VAL inputted from the motion detection unit 110, and determines the to-be-interpolated intra-field data according to the detection result.

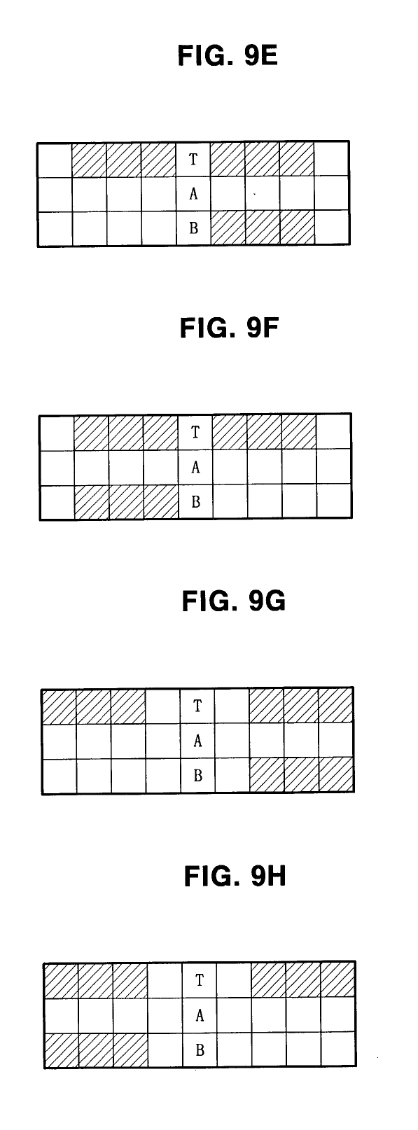

The inputted interlaced scanning film image is made by converting the progressive scanning film image of 24 Hz into the interlaced scanning form of 60 Hz. At this time, it is made by alternating one frame by two fields or three fields. In order for the progressive scanning without any degradation of picture quality, the to-be-interpolated line must be generated using the fields generated in the same frame. In case of a general progressive scanning apparatus, if the current field is T2 of the film interlaced signal shown in FIG. 11(1), data is taken not from B2 of the film interlaced signal shown in FIG. 11(1) but from the previous field B1 when generating B2 of the field signal of the to-be-interpolated line and then the data is interpolated or vertical-interpolated in the current field. In this case, the picture quality is degraded and a flicker occurs.

In order to solve the above problems, the present invention automatically detects the film image from the inputted interlaced scanning image and takes the to-be-interpolated data from the correct field according to the detection result, so that the picture quality of the original image is not degraded. In addition, the inputted image is converted into the progressive scanning image of 60 Hz.

The motion calculation unit 91 of the film image processing unit 130 shown in FIG. 5 uses the motion value M_VAL inputted from the motion detection unit 110 of FIG. 1. At this time, the motion calculation unit 91 calculates a sum of the motion values M_VAL of the respective pixels in the current field. If the sum of the motion values M_VAL of the respective pixels is greater than a predetermined reference value TH_MOTION, the current field is determined as a field having the motion, so that the motion field signal F_M of a high level is provided to the film mode detection unit 92. If the sum is less than the reference value TH_MOTION, the current field is determined as a field having no motion, so that the motion field signal of a low level is provided to the film mode detection unit 92.

Using the motion field signal F_M, the film mode detection unit 92 detects whether or not the inputted original image is the film image through a correlation filter with five taps and outputs the film mode signal FILM_EN and the next field signal N_F to the synthesis unit 190 according to the detection result. As can be seen from the film interlaced signal of FIG. 11(1), T1 and B1 are fields generated in the same frame and T2, B2 and T21 are fields generated in the same frame. B4, T4 and B41 are fields generated in the same frame and B3 and T3 are fields generated in the same frame. The images are inputted by repeating the above process. In this case, if the current field in FIG. 11 is T21 or B41, the current field is a field having no motion since T21 and B41 are fields generated in the same frames as (T2, B2) and (B4, T4), respectively.

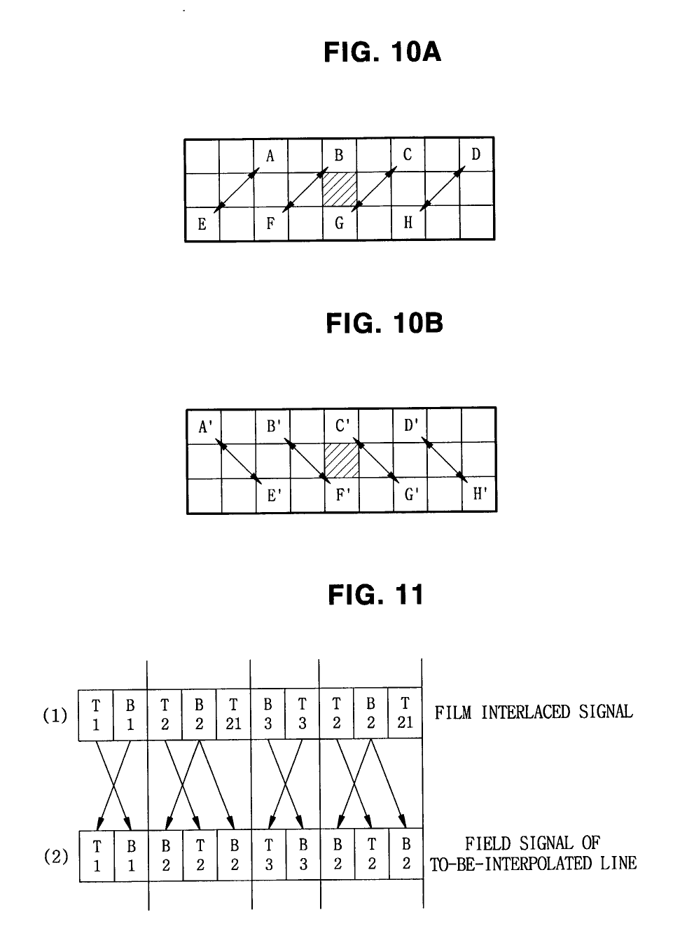

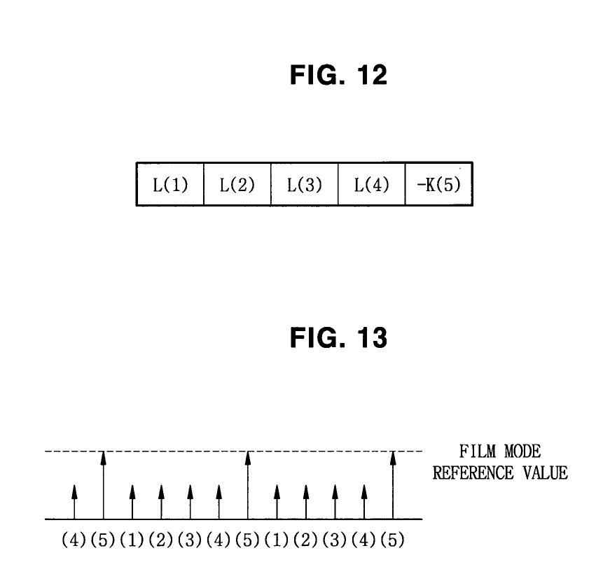

If the motion field signal F_M is a high level, the film mode detection unit 92 changes it into the integer “1” and generates an integer string. If the motion field signal F_M is a low level, the film mode detection unit 92 changes it into the integer “−1” and generates an integer string. Then, these are passed through the correlation filter having five taps shown in FIG. 12. If the original image is the film image, as described above, there is every probability that there are the motions in the fields of T1, B1, T2, B2, B3, T3, B4 and T4, shown in FIG. 11, so that most of them are the integer “1”. Since there is no motion in the fields of T21 and B41, they become the integer “−1”. FIG. 12 illustrates an example showing the defined count values of the respective taps of the correlation filter. Here, by making the count value L to be greater than the count value L, periods (e.g., T1 to T21, or B3 to B41) having no motion in the fifth field among a series of five fields are founded. In other words, as the field data of the film image are sequentially inputted, if the period of the film mode is correct, the output of the correlation filter is converged to the film mode reference value F_VAL determined by the count values K and L. If the period of the film mode is not correct, the output of the correlation filter is converged to a value less than the film mode reference value F_VAL. Using this, the period of the film mode can be founded. If the original image is not the film image, there may be or may not be the motion in fields of all the positions. Therefore, since the integer (1 or −1) converted according to the motion field signal F_M inputted from the motion calculation unit 91 is inputted randomly, the output of the correlation filter is not converged but diverged to a specific value. By passing the inputted interlaced scanning image through the correlation filter, it is determined whether or not the original image is the film image. If the original image is determined as the film image, the film mode signal FILM_EN of a high level is outputted. Then, the film position value F_POS is determined according to the period of the film mode found by the correlation filter and provided to the film selection unit 93. The field position value F_POS is expressed by integers of 1 to 5, and one example is shown in parentheses of FIG. 12. FIG. 13 shows the output of the correlation filter in case the field data of the film image are sequentially inputted. As described above, it can be seen that the output of the correlation filter is converged to the film mode reference value F_VAL one time at every five fields. The integers (1 to 5) of the parentheses of FIG. 13 mean the positions of the same fields as the integers (1 to 5) of the parentheses of FIG. 12. Here, the field of the integer “5” is a field corresponding to the fields T21 or B41 having no motion in the film interlaced signal of FIG. 11.

In case the original image is the film image, when the interpolation is performed so as to convert the inputted interlaced scanning image into the progressive scanning image, the to-be-interpolated line must be generated using the field generated in the same frame, as shown in the field signal of the to-be-interpolated line of FIG. 11(2). For this, in case of the fields having the field position values F_POS of 1 and 3 in the parentheses of FIG. 12, the to-be-interpolated data must be taken from the next field. In case of the fields having the field position values F_POS of 1, 4 and 5, the to-be-interpolated data must be taken from the previous field. Accordingly, in case of the field having the field position values F_POS of 1 and 3, the field selection unit 93 of FIG. 5 outputs the next field signal N_F of a high level to the synthesis unit 190 using the field position value F_POS inputted from the film mode detection unit 92, thereby allowing the to-be-interpolated data to be taken from the next field. In case of the fields having the field position values F_POS of 2, 4 and 5, the field selection unit 93 outputs the next field signal N_F of a low level to the synthesis unit 190, thereby allowing the to-be-interpolated data to be taken from the previous field.

In case of the fields having the field position values F_POS of 1 and 3, the to-be-interpolated data must be taken from the next field. For this, if the film mode signal FILM_EN is a high level, the previous field data I of FIG. 1 are made to be the current field data. In other words, in case of the film image, it is possible to take the to-be-interpolated data from the next field by changing the position of the current field into the previous field.

Meanwhile, with the intra-field interpolation data INTRA_OUT inputted from the boundary processing unit 100, the previous field data I and the tow-field delayed image data J1 or J2, the synthesis unit 190 of FIG. 1 selects and outputs the final data using the motion value M_VAL inputted from the motion detection unit 110, the fast motion signal FAST_EN inputted from the fast image processing unit 120, and the film mode signal FILM_EN and the next field signal N_F, which are inputted from the film image processing unit 130.

If the synthesis unit 190 receives the fast motion signal FAST_EN of a high level from the fast image processing unit 120, it can recognize the presence of the fast motion. Therefore, the synthesis unit 190 outputs the intra-field interpolation data INTRA_OUT, which is inputted from the boundary processing unit 100, as the to-be-interpolated data via the output port 192. If the synthesis unit 190 receives the film mode signal FILM_EN of a high level from the film image processing unit 130, it can recognize that the original image is the film image. Therefore, as described above, the previous field data I is made to be the current field data. If the next field signal N_F inputted from the film image processing unit 130 is a high level, the synthesis unit 190 outputs the pixels of the next field C1 or C2 via the output port 192. If the next field signal N_F is a low level, the synthesis unit 190 outputs the two-field delayed image data J1 or J2 via the output port 192. If there is neither the fast motion image nor the film image, in case the motion value M_VAL inputted from the motion detection unit 110 is a high level, the synthesis unit 190 outputs the previous field data I via the output port 192. If the motion value M_VAL is a low level, the synthesis unit 190 outputs the intra-field interpolation data INTRA_OUT inputted from the boundary processing unit 100 via the output port 192.

Meanwhile, in the prior art, only the boundary portions of angle of 45° are interpolated using one line storage device, or the fast motion image or the film image is not automatically detected and interpolated through the fast image processing unit or the film image processing unit. Generally, by performing the intra-field vertical interpolation or the line repetition, the picture quality after the progressive scanning is degraded, or three field memory devices are used so as to process the fast motion image. However, unlike the prior art, the present invention automatically detects the boundary portions of the several angles in the image signal provided when the image of the interlaced scanning mode is converted into that of the progressive scanning mode, and interpolates the lines along the boundary portions. Then, the present invention detects the fast image using two field memory devices and properly interpolates it. Then, the present invention automatically detects the film image of 24 Hz and interpolates it.

The present invention can solve the problems of step phenomenon or saw-tooth phenomenon caused by the time difference between two fields when the image of the interlaced scanning mode is converted into that of the progressive scanning mode, thereby improving the definition of the boundary portions. In addition, the present invention can solve the problem of the horizontal moire remaining image with respect to partial image having the fast motion. Further, the present invention can improve the picture quality by recovering the film mode image to be close to the original image.

It will be apparent to those skilled in the art that various modifications and variations can be made in the present invention. Thus, it is intended that the present invention covers the modifications and variations of this invention provided they come within the scope of the appended claims and their equivalents.

As described above, according to the present invention, the line interpolation apparatus and method of image signals automatically detects the boundary portions of the several angles in the image signal provided when the image of the interlaced scanning mode is converted into that of the progressive scanning mode, and interpolates the lines along the boundary portions, so that the definition of the boundary portions is improved. Further, the present invention can solve the problem of the horizontal moire remaining image with respect to partial image having the fast motion. Furthermore, the picture quality is entirely improved by recovering the film mode image to be close to the original image and it is possible to implement hardware more simply.

What is claimed is:

1. A method for deinterlacing image signals, the method comprising the steps of:
(a) extracting motion values with respect to to-be-interpolated pixels using current field data and two-field delayed data;
(b) dividing one intra-field pixels into partial images based on block unit, and determining whether or not corresponding partial image has a motion using the extracted motion values;
(c) determining whether or not the corresponding partial image has a fast motion using the determination result of the step (b) and the determination result of a one-field delayed data;
(d) cumulatively counting the determination result of the step (b) for all fields and determining whether or not the current field is a motion field;
(e) determining whether or not an inputted image is a film image using data sequentially storing the determination result of the step (b) for several fields;
(f) if the inputted image is the film image, synthesizing sequential two fields contained in the same frame to make a progressive scanning image;
(g) if the inputted image is not the film image, determining that there is no motion according to the extracted motion values of the respective pixels, and if the inputted image is not a pixel contained in the partial image having the fast motion, performing an intra-field interpolation to obtain an interpolation pixel value; and
(h) finding a directionality of boundary of surroundings of to-be-interpolated pixels with respect to the other pixels using pixels of current and just previous lines of a predetermined field, and calculating to-be-interpolated pixel value according to the directionality.

2. A method for deinterlacing image signals, the method comprising the steps of:
(a) finding boundary portions between image data of line of a predetermined current field and image data of a previous line, and obtaining to-be-interpolated data within field according to the boundary portions;
(b) extracting a motion value using the image data of the current field and two-field delayed image data;
(c) extracting a film image based on the extracted motion value;
(d) comparing the extracted motion value with a one-field delayed motion value and detecting a fast motion image; and
(e) generating image data by interpolating lines of the obtained to-be-interpolated data and the previous field data according to the motion value, the detected fast motion image and the detected film image.

3. The method of claim 2, wherein the boundary portions have at least the directionality of 18°, 27°, 45°, 90°, 135°, 153° and 162°.

4. The method of claim 2, wherein the step (a) includes the steps of:
(a1) calculating a difference value between an upper pixel and a lower pixel among the image data corresponding to surroundings of a to-be-interpolated position during the interpolation of the boundary portions to classify a line boundary and a surface boundary by comparing the difference value with a reference value, and extracting difference values of pixels having a directionality through a separate process according to the classified boundary type;
(a2) selecting a minimum value of a positive direction and a minimum value of a negative direction among the extracted difference values of pixels having several directionalities, the positive direction being in the range of 0° to 90°, the negative direction being in the range of 90° to 180;
(a3) extracting a to-be-interpolated final boundary direction by comparing the minimum of the positive direction, the minimum of the negative direction, the positive direction and the negative direction, based on the image data of the current field and the image data of the previous line; and
(a4) extracting a pixel value of the to-be-interpolated line according to the extracted final boundary direction.

5. The method of claim 3 or claim 4, wherein the difference value of the pixels having the directionality is extracted by detecting error of the boundary portions of 18°, 27°, 153° and 162° among the boundary portions.

6. The method of claim 4, wherein the final direction boundary is extracted using a difference of comparison value between the positive direction and the negative direction when the positive direction and the negative direction are compared with each other.

7. The method of claim 4, wherein a difference of pixels having the positive/negative direction of 45° is used to find the directionality when the positive direction and the negative direction are compared with each other.

8. The method of claim 4, wherein the directionality is found using a reference value when the positive direction and the negative direction are compared with each other.

9. The method of claim 2, wherein the step (c) includes the steps of:
(c1) accumulating the motion values based on pixels of the current field according to the extracted motion value, and detecting the presence of the motion of the current filed by comparing the motion value with a reference value;
(c2) setting a difference of a count value between a field having a motion and a field having no motion, and extracting a period of a correct film mode in a form of convergence or divergence using a correlation filter having taps, the number of taps being a multiple of 5; and
(c3) determining a to-be-interpolated field according to the extracted period of the film mode.

10. The method of claim 9, wherein, if the film image is detected, the interpolation is performed by changing the current field into the previous field.

11. The method of claim 9, wherein, if the film image is detected, it is determined which one among a next field data and a previous field data is used when performing the interpolation.

12. The method of claim 9, wherein the period of the film mode is a period having fields corresponding to a multiple of at least 5.

13. The method of claim 9, wherein, in the step (c2), a large weight is set to a field having no motion and the period of the film mode is extracted through a characteristic that an output of the correlation filter is converged to a predetermined value.

14. The method of claim 2, wherein the fast motion image is detected by comparing the extracted motion value with the one-field delayed motion value according to pixels.

15. An apparatus for deinterlacing image signals, the apparatus comprising:
(a) a boundary processing means for finding boundary portions between image data of line of a predetermined current field and image data of a previous line, and obtaining to-be-interpolated data within field according to the boundary portions;
(b) a motion detection means for detecting a motion value using the image data of the current field and two-field delayed image data;
(c) a film image processing means for detecting a film image based on the extracted motion value and determining a to-be-interpolated field data according to the detected film image;
(d) a fast image processing means for comparing the detected motion value with a one-field delayed motion value and detecting a fast motion image; and
(e) a synthesis means for generating image data by selectively interpolating lines of the obtained to-be-interpolated data and the previous field data according to the detected motion value, the detected fast motion image and the detected film image.

16. The apparatus of claim 15, wherein the boundary processing means includes:
(a1) a boundary-based difference value generation means for generating difference values with respect to directionalities of several angles using upper and lower pixels among line image data of the current field and the one-line delayed image data;
(a2) a boundary detection means for distinguishing a line boundary and a surface boundary by comparing a reference value with a difference value of pixels having a predetermined slope in the directionalities of the several angles using the upper and lower pixels among the line image data of the current field and the one-line delayed image data, and detecting the presence of boundary with respect to the respective directionalities through a separate process according to the distinguished boundary types to thereby outputting a boundary presence signal;
(a3) a directionality selection means for obtaining a directionality of a finally to-be-interpolated boundary using the line image data of the current field, the one-line delayed image data, the difference values with respect to the directionalities of the several angles, and the boundary presence signal;
(a4) a direction-based average value generation means for generating average values of pixels with respect to the directionalities of the several angles using the line image data of the current field and the one-line delayed image data;
(a5) a pixel selection means for selecting one of the average values based on a boundary direction selection signal and a boundary angle magnitude signal, which are outputted from a boundary direction selection means, and outputting a to-be-interpolated current pixel value;
(a6) a median filter for removing noise components and performing a grouping operation using the to-be-interpolated current pixel value, an interpolated previous pixel value and a to-be-interpolated next pixel value; and
(a7) a multiplexing means for selecting one of the pixel value inputted from the median filter and the to-be-interpolated current pixel value selected by the pixel selection means, and outputting the selected pixel value as a to-be-interpolated intra-field data.

17. The apparatus of claim 16, wherein the directionality selection means includes:
(a31) a positive-direction minimum value selection means for outputting a positive-direction minimum difference value and a positive-direction angle value with respect to the directionalities of boundary having angles of 0° to 90° using the difference values and the boundary presence signal with respect to the directionalities of the several angles;
(a32) a negative-direction minimum value selection means for outputting a negative-direction minimum difference value and a negative-direction angle value with respect to the directionalities of boundary having angles of 90° to 180° using the difference values and the boundary presence signal with respect to the directionalities of the several angles;
(a33) an absolute value generation means for calculating and outputting an absolute value of a difference between an absolute value of the positive-direction minimum difference value and that of the negative-direction minimum difference value;
(a34) a directionality detection means for calculating and outputting a positive direction value and a negative direction value using upper and lower pixels among the line image data of the current field and the one-line delayed image data, the positive and negative direction values representing an entire directionality of boundary; and
(a35) a boundary direction selection means for obtaining the boundary direction selection value by determining a directionality of a final boundary using the positive direction value, the negative direction value, the absolute value outputted from the absolute value generation means, the predetermined boundary reference value, the positive-direction minimum difference value and the negative-direction minimum difference value, which are inputted from the positive-direction minimum value selection means and the negative-direction minimum value selection means according to an absolute reference value, and obtaining and outputting the boundary angel magnitude signal indicating that the angle of the boundary direction is large or small according to the directionality of the determined boundary.

18. The apparatus of claim 17, wherein, if the positive-direction minimum difference value and the negative-direction minimum difference value are simultaneously less than the predetermined boundary reference value and the absolute value of the difference between the positive-direction minimum difference value and the negative-direction minimum difference value is less than the absolute reference value, the boundary direction selection means determines that the directionality of boundary is in the range of 0° to 90° when the positive direction value is greater than the negative direction value, and the boundary direction selection means determines that the directionality of boundary is in the range of 90° to 180° when the negative direction value is greater than the positive direction value.

19. The apparatus of claim 17 or claim 18, wherein, if the absolute value of the difference between the positive-direction minimum difference value and the negative-direction minimum difference value is greater than the absolute reference value, the boundary direction selection means determines a direction having a small value among the positive-direction minimum difference value and the negative-direction minimum difference value as a final direction of boundary.

20. The apparatus of claim 20, wherein, if the positive-direction minimum difference value is less than the predetermined boundary reference value and the negative-direction minimum difference value is greater than the predetermined boundary reference value, the boundary direction selection means determines the positive direction as the final direction, and
if the positive-direction minimum difference value is greater than the predetermined boundary reference value and the negative-direction minimum difference value is less than the predetermined boundary reference value, the boundary direction selection means determines the negative direction as the final direction

21. The apparatus of claim 17, wherein, if both the positive-direction minimum difference value and the negative-direction minimum difference value are greater than the predetermined boundary reference value, the boundary direction selection means determines that there is no slope of the positive direction or negative direction and determines the direction of 90° as the final direction of boundary.

22. The apparatus of claim 15, wherein the film image processing means includes:
(c1) a motion calculation means for accumulating the motion values based on pixels of the current field according to the detected motion value, and detecting the presence of the motion of the current filed by comparing the motion value with a reference value;
(c2) a film mode detection means for setting a difference of a count value between a field having a motion and a field having no motion, and detecting a field position of a period of a correct film mode in a form of convergence or divergence using a correlation filter having 5 taps; and
(c3) a field selection means for determining a to-be-interpolated field data according to the detected field position of the period of the film mode.

23. The apparatus of claim 22, wherein the period of the film mode is a period having fields corresponding to a multiple of at least 5.

24. The apparatus of claim 15, wherein the fast image processing means includes:
(d1) a field delay means for delaying the motion value corresponding to one field detected by the motion detection means; and
(d2) an image comparison means for comparing the motion value detected by the motion detection means with the one-field delayed motion value based on pixel units, and determining the motion.
